(19) United States
(12) Patent Application Publication
(10) Pub. No.: US 2025/0149719 A1
(43) Pub. Date: May 8, 2025

(54) POWER STORAGE DEVICE

(71) Applicant: TOYOTA JIDOSHA KABUSHIKI KAISHA, Toyota-shi (JP)

(72) Inventor: Takuya TOMIOKA, Toyota-shi (JP)

(73) Assignee: TOYOTA JIDOSHA KABUSHIKI KAISHA, Toyota-shi (JP)

(21) Appl. No.: 18/761,776

(22) Filed: Jul. 2, 2024

(30) Foreign Application Priority Data
Nov. 2, 2023 (JP) 2023-188453

(51) Int. Cl. H01M 50/264; H01M 50/204; H01M 50/291

(52) U.S. Cl. CPC H01M 50/264; H01M 50/204; H01M 50/291; H01M 2220/20

(57) ABSTRACT

The power storage device includes a power storage stack including a plurality of power storage cells, a case that opens upward and accommodates the power storage stack, and a restriction member that restricts upward separation of the power storage stack from the case. The case includes a side wall provided on a side of the power storage stack in one direction. The restriction member includes a fixed restriction portion fixed to the side wall, and an interposed restriction portion interposed between the fixed restriction portion and the power storage stack. The fixed restriction portion has a shape in which the thickness in the one direction gradually increases toward the upper side. The interposed restriction portion has a shape in which the thickness in the one direction gradually increases toward the lower side.

### CROSS-REFERENCE TO RELATED APPLICATION

This application claims priority to Japanese Patent Application No. 2023-188453 filed on Nov. 2, 2023, incorporated herein by reference in its entirety.

### BACKGROUND

### 1. Technical Field

The present disclosure relates to a power storage device.

### 2. Description of Related Art

For example, Japanese Unexamined Patent Application Publication No. 2020-87704 (JP 2020-87704 A) discloses a battery pack including a battery stack including a plurality of battery cells, a battery case, and a shim. The shim is disposed between the battery stack and the side wall of the battery case.

### SUMMARY

In the battery pack described in JP 2020-87704 A, there is room for improvement to suppress upward detachment of the battery stack from the battery case.

An object of the present disclosure is to provide a power storage device in which upward detachment of a power storage stack from a case can be restricted.

A power storage device according to an aspect of the present disclosure includes:
a power storage stack including a plurality of power storage cells disposed side by side in one direction;
a case that is open upward and houses the power storage stack; and
a restriction member that restricts upward detachment of the power storage stack from the case.
   The case includes a side wall provided on a side of the power storage stack in the one direction.
   The restriction member includes a fixed restriction portion fixed to the side wall, and an interposed restriction portion interposed between the fixed restriction portion and the power storage stack.
   The fixed restriction portion has a shape in which a thickness in the one direction gradually increases upward.
   The interposed restriction portion has a shape in which a thickness in the one direction gradually increases downward.

According to the present disclosure, it is possible to provide the power storage device in which the upward detachment of the power storage stack from the case can be restricted.

### BRIEF DESCRIPTION OF THE DRAWINGS

Features, advantages, and technical and industrial significance of exemplary embodiments of the dislosure will be described below with reference to the accompanying drawings, in which like signs denote like elements, and wherein:

FIG. 1 is a cross-sectional view schematically illustrating a power storage device according to an embodiment of the present disclosure; and

FIG. 2 is a cross-sectional view schematically illustrating a state in which the power storage stack and the interposed restriction portion are moved upward with respect to the case.

### DETAILED DESCRIPTION OF EMBODIMENTS

Embodiments of the present disclosure will be described with reference to the drawings. In the drawings referred to below, the same or corresponding members are denoted by the same reference numerals.

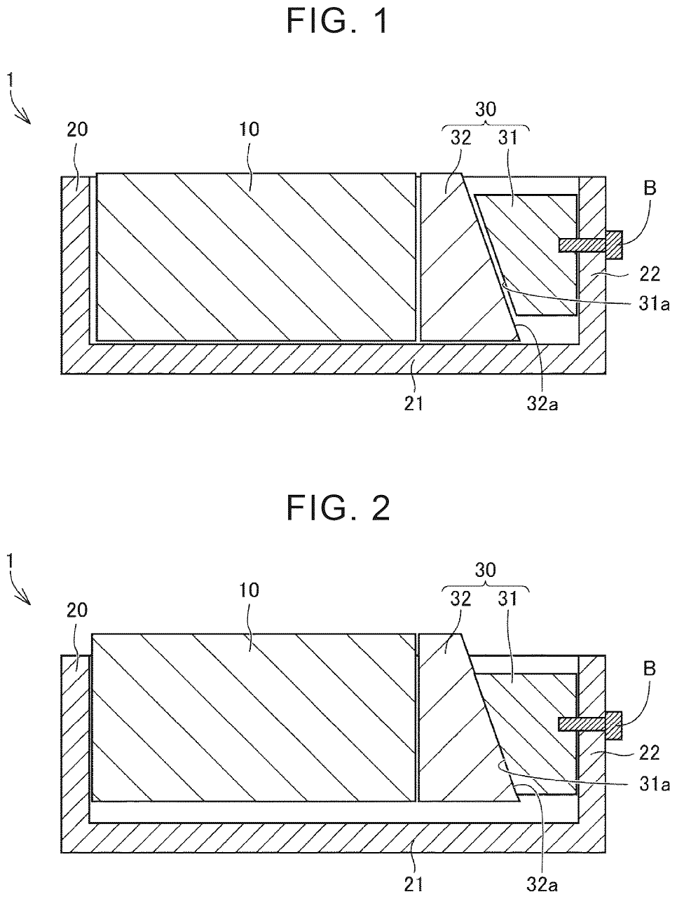

FIG. 1 is a cross-sectional view schematically illustrating a power storage device according to an embodiment of the present disclosure. The power storage device 1 is mounted on, for example, a bottom portion (not shown) of the vehicle.

As illustrated in FIG. 1, the power storage device 1 includes a power storage stack 10 including a plurality of power storage cells, a case 20, and a restriction member 30.

The power storage stack 10 includes a plurality of power storage cells arranged in one direction (the left-right direction in FIG. 1). The power storage stack 10 may have a spacer (resin frame) disposed between a pair of power storage cells adjacent to each other.

The case 20 is opened upward and houses the power storage stack 10. The case 20 has a bottom wall 21 provided below the power storage stack 10, and a side wall 22 provided on the side of the power storage stack 10 in one direction. The side wall 22 is formed of a part of a peripheral wall. The peripheral wall is erected from the bottom wall 21 and surrounds the power storage stack 10. In the present embodiment, the peripheral wall is formed in a quadrangular cylindrical shape.

The restriction member 30 restricts the upward separation of the power storage stack 10 from the case 20. The restriction member 30 is disposed in the case 20. The restriction member 30 includes a fixed restriction portion 31 and an interposed restriction portion 32.

The fixed restriction portion 31 is fixed to the side wall 22. In the present embodiment, the fixed restriction portion 31 is fixed to the side wall 22 by the bolt B. The fixed restriction portion 31 has a shape in which the thickness in one direction gradually increases as it goes upward. The fixed restriction portion 31 has a fixed inclined surface 31a formed by an inner end surface in one direction. The fixed inclined surface 31a is inclined so as to gradually separate from the side wall 22 toward the upper side. The fixed inclined surface 31a may extend from the lower end portion to the upper end portion of the fixed restriction portion 31.

The interposed restriction portion 32 is interposed between the fixed restriction portion 31 and the power storage stack 10. The interposed restriction portion 32 may be fixed to the power storage stack 10 by appropriate means. The interposed restriction portion 32 has a shape in which the thickness in one direction gradually increases as it goes downward. The interposed restriction portion 32 has an interposed inclined surface 32afacing the fixed inclined surface 31a. The interposed inclined surface 32a is inclined so as to gradually approach the side wall 22 as it goes downward. The interposed inclined surface 32a may extend from the lower end portion to the upper end portion of the interposed restriction portion 32.

The sum of the dimension of the upper end portion of the fixed restriction portion 31 in one direction, the dimension of the lower end portion of the interposed restriction portion 32 in one direction, and the dimension of the power storage stack 10 in one direction is larger than the dimension of the upper end portion (opening portion) of the case 20 in one direction. Therefore, as shown in FIG. 2, even when the power storage stack 10 and the interposed restriction portion 32 move upward with respect to the case 20 due to vibrations or the like, the interposed inclined surface 32a abuts against the fixed inclined surface 31a, thereby increasing the restraining force of the power storage stack 10 in one direction. Therefore, detachment of the power storage stack 10 from the case 20 is suppressed.

It will be understood by those skilled in the art that the exemplary embodiments described above are illustrative of the following aspects.

### First Aspect

A power storage device includes: a power storage stack including a plurality of power storage cells arranged side by side in one direction;
a case which is open upward and accommodates the power storage stack; and
a restriction member for restricting the upward separation of the power storage stack from the case.

The case includes a side wall provided on a side of the power storage stack in the one direction.

The restriction member includes:
a fixed restriction portion fixed to the side wall, and
an interposed restriction portion interposed between the fixed restriction portion and the power storage stack.

The fixed restriction portion has a shape in which the thickness in the one direction gradually increases toward the upper.

The interposed restriction portion has a shape in which a thickness in the one direction gradually increases in a downward direction.

In this power storage device, as the power storage stack and the interposed restriction portion move upward with respect to the case, the interposed restriction portion abuts against the fixed restriction portion, thereby increasing the restraining force of the power storage stack in one direction. Therefore, detachment of the power storage stack from the case is suppressed.

### Second Aspect

The power storage device according to aspect 1, wherein the interposed restriction portion is fixed to the power storage stack.

### Third Aspect

The power storage device according to any one of aspects 1 and 2, wherein a sum of a dimension of an upper end portion of the fixed restriction portion in the one direction, a dimension of a lower end portion of the interposed restriction portion in the one direction, and a dimension of the power storage stack in the one direction is larger than a dimension of an upper end portion of the case in the one direction.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage device comprising:
a power storage stack including a plurality of power storage cells disposed side by side in one direction;
a case that is open upward and houses the power storage stack; and
a restriction member that restricts upward detachment of the power storage stack from the case, wherein
the case includes a side wall provided on a side of the power storage stack in the one direction,
the restriction member includes:
a fixed restriction portion fixed to the side wall; and
an interposed restriction portion interposed between the fixed restriction portion and the power storage stack,
the fixed restriction portion has a shape in which a thickness in the one direction gradually increases upward, and
the interposed restriction portion has a shape in which a thickness in the one direction gradually increases downward.

2. The power storage device according to claim 1, wherein the interposed restriction portion is fixed to the power storage stack.
